(19) United States
(12) Patent Application Publication
(10) Pub. No.: US 2013/0124991 A1
(43) Pub. Date: May 16, 2013

(54) AUDIO PLAYBACK DEVICE AND METHOD OF CONTROLLING AN AUDIO PLAYBACK DEVICE

(71) Applicants: YING-CHUAN YU, Tu-Cheng (TW); YING-XIONG HUANG, Tu-Cheng (TW)

(72) Inventors: YING-CHUAN YU, Tu-Cheng (TW); YING-XIONG HUANG, Tu-Cheng (TW)

(73) Assignee: HON HAI PRECISION INDUSTRY CO., LTD., Tu-Cheng (TW)

(21) Appl. No.: 13/316,461

(22) Filed: Dec. 10, 2011

(30) Foreign Application Priority Data
Nov. 11, 2011 (TW) 100141147

(51) Int. Cl. G06F 3/048

(52) U.S. Cl. 715/716

(57) ABSTRACT

An exemplary audio playback method is applied on an audio playback device. The audio playback device includes a touch screen and a storage unit. The storage unit stores audio files. The method includes controlling the touch screen to display a playlist and a scroll bar comprising a scroll block for operating. The method then associates the position of the scroll block in the scroll bar with the audio files. Next, the method detects whether the scroll block is operated. Lastly, the method determines the position of the scroll block in the scroll bar when the scroll block is dragged, and selects one audio file at least according to the determined position of the scroll block in the scroll bar.

### BACKGROUND

1. Technical Field

The present disclosure relates to audio playback devices and methods for controlling the audio playback devices and, particularly, to an audio playback device for conveniently controlling playing process of the audio playback device and a method.

2. Description of Related Art

A conventional audio playback device is activated to select desired audio file to playback audio files in response to input by a user on mechanical buttons of the audio playback device or touch input on a touch screen of the audio playback device. However, if the mechanical buttons are used to select a desired audio file, the user must press the buttons continuously until the desired audio file is found, which is time consuming to operate. If touch input on the touch screen is used to select the desired audio file, a touch on the touch screen only makes the user review the audio files listed in the playlist, the user should select the desired audio file from the playlist displayed in the touch screen manually. It is desired for an audio playback device to overcome the above shortcomings.

### BRIEF DESCRIPTION OF THE DRAWINGS

The components of the drawings are not necessarily drawn to scale, the emphasis instead being placed upon clearly illustrating the principles of the present disclosure. Moreover, in the drawings, like reference numerals designate corresponding parts throughout several views.

FIG. 1 is a block diagram of an audio playback device in accordance with an exemplary embodiment.

FIG. 2 is a block diagram of a processor of the audio playback device of FIG. 1.

FIG. 3 is an overview illustrating a touch screen including a scroll bar and a playlist in according to an exemplary embodiment.

FIG. 4 is a flowchart of a method for controlling an audio playback device in accordance with an exemplary embodiment.

### DETAILED DESCRIPTION

The embodiments of the present disclosure are described in detail, with reference to the accompanying drawings.

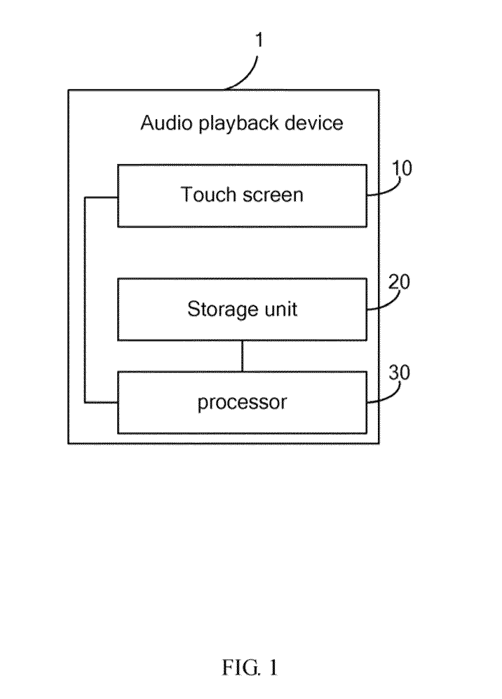

Referring to FIG. 1, a block diagram of an audio playback device 1 in accordance with an exemplary embodiment is shown. The audio playback device 1 includes a touch screen 10, a storage unit 20, and a processor 30.

The storage unit 20 stores audio files, general information associated with each of the audio files, and application programs running on the audio play device 1. The general information of each audio file may include a singers name, an audio file title, a document size, play time, and a music style. In the embodiment, the general information of each audio file further includes a number for recording an order position of the audio file stored in the storage unit 20 or in an audio folder stored in the storage unit 20. For example, if an order position of an audio file titled “You Are Not Alone”, stored in the storage unit 20 or in the audio folder is 26, the number of the audio file is 26 too.

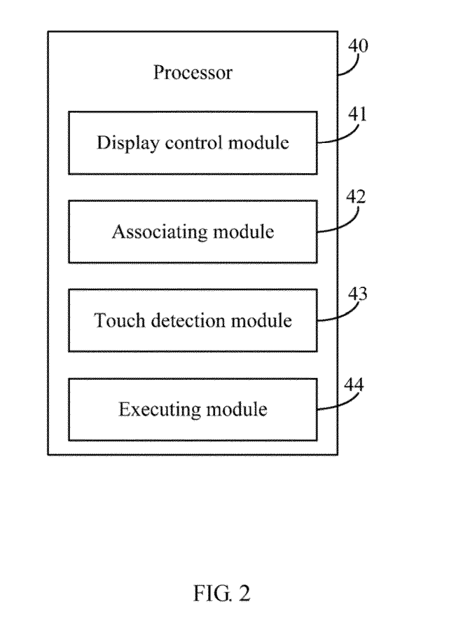

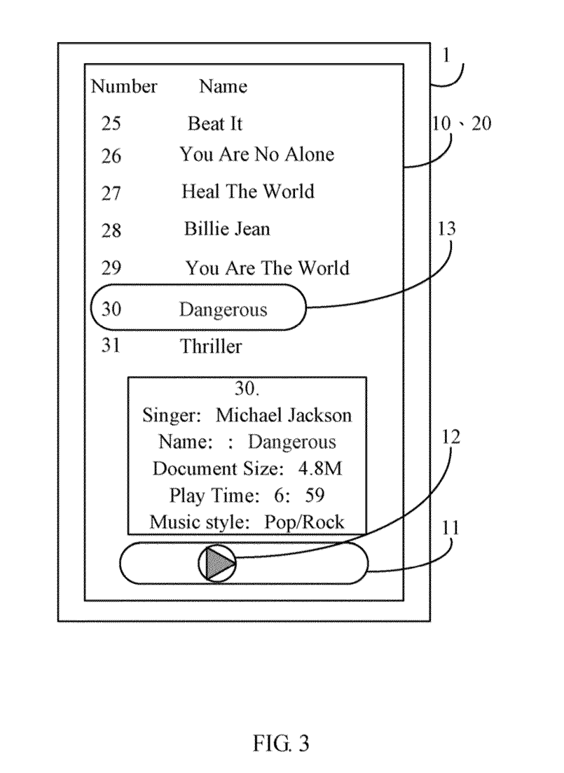

Referring to FIG. 2, the processor 30 includes a display control module 31, an associating module 32, a touch detection module 33, and an executing module 34. The display control module 31 is to control the touch screen 10 to display a playlist of the audio files and a scroll bar 11, as shown in FIG. 3. The scroll bar 11 includes a scroll block 12 for operating. In the embodiment, the name and the number of each audio file is displayed in the playlist. In an alternative embodiment, only the name of each audio file is displayed in the playlist. In the embodiment, the scroll bar 11 is a horizontal scroll bar 11 and is displayed below the playlist. The position where the scroll bar 11 located on the touch screen 10 and the shape of the scroll bar 11 can be various in another embodiment.

The associating module 32 is to associate the position of the scroll block 12 in the scroll bar 11 with the audio files stored in the storage unit 20 or in the audio folder. In a first embodiment, the associating module 32 divides the scroll bar 11 into a number of parts according to the total number of the audio files, and associates each part of scroll bar 11 where the scroll block 12 is operable to move from one part to the nearest next one to select the next audio file in a sequence. For example, when the total number of the audio files is 100, the associating module 32 divides the scroll bar 11 into 100 parts. Associates each part with one audio file in sequence, thus the scroll block 12 at the first part of the scroll bar 11 corresponds to the audio file whose number is 1, and the scroll block 12 at the last part of the scroll bar 11 corresponds to the audio file whose number is 100.

In a second embodiment, the associating module 32 divides the scroll bar 11 into a number of parts according to a preset distance and the length of the scroll bar 11. Divides the number of each audio file by the number of parts to determine a remainder, which is used to determine which part of the scroll bar lithe audio file is associated with. Then associates each part of scroll bar 11 where the scroll block 12 is located with audio files in sequence according to the determined reminder. For example, when the preset distance is 1 cm and the length of the scroll bar 11 is 10 cm, the associating module 32 divides the scroll bar 11 into 10 parts. Thus, the audio file whose number is 1 is associated with the first part of the scroll bar 11, the audio file whose number is 10 is associated with the tenth part of the scroll bar 11, the audio file whose number is 11 is associated with the first part of the scroll bar 11.

The touch detection module 33 is to detect whether the scroll block 12 is double clicked or dragged. When the touch detection module 33 detects that the scroll block 12 is double clicked, the executing module 34 switches the state of the audio playback device 1 between a playing state and a stop state. That is, when the audio playback device 1 is playing an audio file, if the double click on the scroll block 12 is detected, the executing module 34 stops playing the audio file and switches the playing state of the audio playback device 1 to the stop state. When the audio playback device 1 is in the stop state, if the double click on the scroll block 12 is detected, the executing module 34 playing the audio file to switch the audio playback device 1 to the playing state.

When the touch detection module 33 detects that the scroll block 12 is dragged, the executing module 34 at least determines the position of the scroll block 12 in the scroll bar 11, and selects one audio file at least according to the determined position of the scroll block 12 in the scroll bar 11. In the first embodiment, the executing module 34 determines which part of the scroll bar 11 the scroll block 12 is located in, and selects the audio file associated with the determined part of the scroll bar 11. In the second embodiment, the executing module 34 determines the times that the scrolled block 12 is dragged from the head of the scroll bar 11 to the end of the scroll bar 11 and which part of the scroll bar 11 the scroll block 12 is located in to select the audio file.

In the embodiment, the executing module 34 further marks the selected audio file. The selected audio file can be marked by highlighting the selected audio file, displaying a frame around the selected audio file, or displaying a cursor on the selected audio file.

In the embodiment, when the executing module 34 selects one audio file in response to the operation of the user, the display control module 31 further controls the touch screen 10 to display the general information associated with the selected audio file. The information associated with the selected audio file can be displayed above the playlist, below the playlist, or other appropriate portions of the touch screen 10.

In the embodiment, the executing module 34 further plays the selected audio file when the touched scroll block 12 is released.

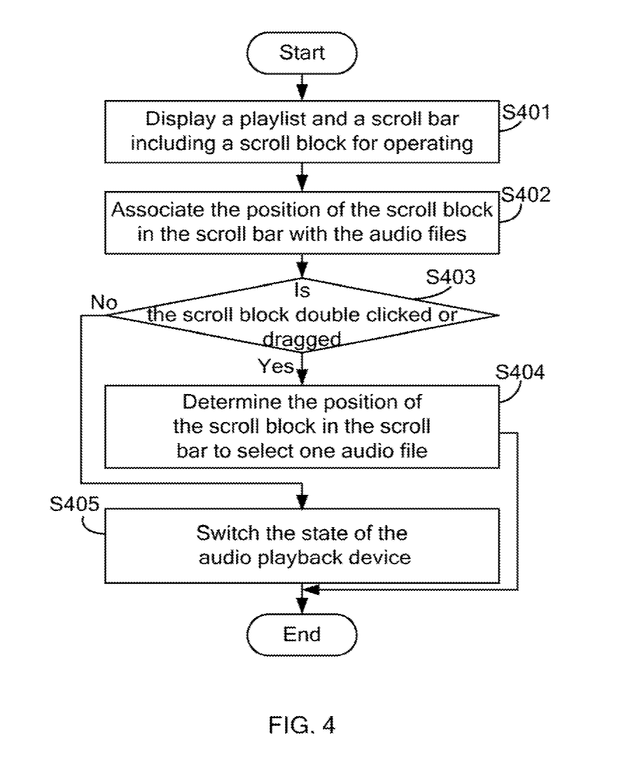

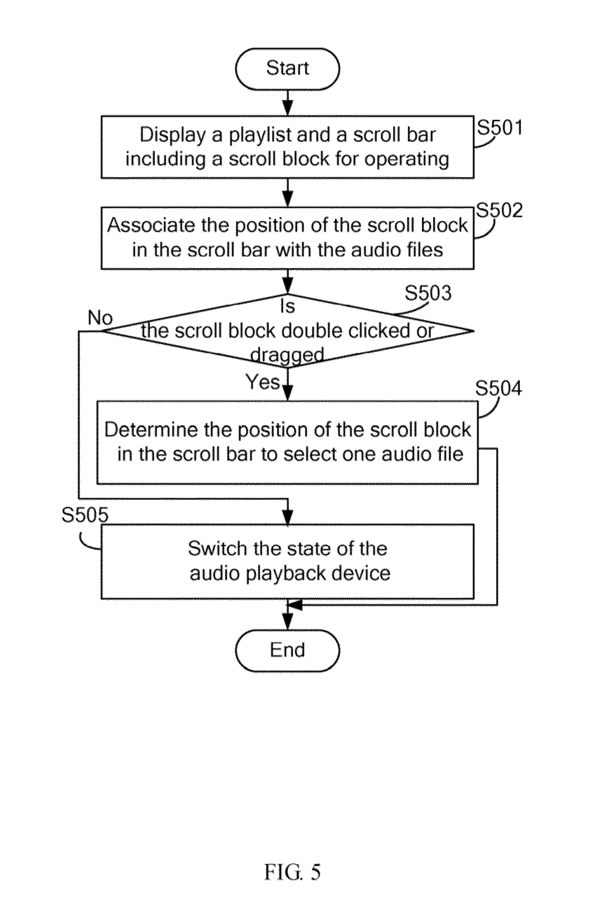

Referring to FIG. 4, a method of controlling the audio playback device 1 in accordance with an exemplary embodiment is shown.

In step S401, the display control module 31 controls the touch screen 10 to display the playlist and the scroll bar 11. The scroll bar 11 includes a scroll block 12 for operating.

In step S402, the associating module 32 associates the position of the scroll block 12 in the scroll bar 11 with the audio files. In the first embodiment, the associating module 32 divides the scroll bar 11 into a number of parts according to the total number of the audio files, and associates each parts of the scroll bar 11 where the scroll block 12 is located with one audio file in sequence. In the second embodiment, the associating module 32 divides the scroll bar 11 into a number of parts according to the preset distance and the length of the scroll bar 11. Divides the number of each audio file by the number of the parts to determine the remainder, which is used to determine which part of the scroll bar 11 is associated with which pat of the audio file. In addition, associates each part of the scroll bar 11 where the scroll block 12 is located with audio files in sequence according to the determined reminder.

In step S403, the touch detection module 33 detects whether the scroll block 12 is double clicked or dragged. When the scroll block 12 is dragged, the procedure goes to step S404. When the scroll block 12 is double clicked, the procedure goes to step S405.

In step S404, the executing module 34 at least determines the position of the scroll block 12 in the scroll bar 11, and selects one audio file at least according to the determined position of the scroll block 12 in the scroll bar 11. In the first embodiment, the executing module 34 determines which part of the scroll bar 11 the scroll block 12 is located in, and selects one audio file associated with the determined part of the scroll bar 11. In the second embodiment, the executing module 34 determines the time(s) that the scroll block 12 is dragged from the head of the scroll bar 11 to the end of the scroll bar 11 and which part of the scroll bar 11 the scroll block 12 is located in to select the audio file.

In step S405, the executing module 34 switches the state of the audio playback device 1 between the playing state and the stop state.

Although the present disclosure has been specifically described on the basis of the exemplary embodiment thereof, the disclosure is not to be construed as being limited thereto. Various changes or modifications may be made to the embodiment without departing from the scope and spirit of the disclosure.

What is claimed is:

1. An audio playback device comprising:
a touch screen;
a storage unit storing audio files;
a display control module to control the touch screen to display a playlist of the audio files and a scroll bar comprising a scroll block for operating;
an associating module to associate the position of the scroll block in the scroll bar with the audio files on the playlist;
a touch detection module to detect whether the scroll block is operated; and
an executing module to determine the position of the scroll block in the scroll bar when the scroll block is dragged and select one audio file according to the determined position of the scroll block in the scroll bar.

2. The audio playback device as described in claim 1, wherein the storage unit further stores general information associated with each of the audio files, the display control module further controls the touch screen to display the general information associated with one of the audio files when the executing module selects the one audio file.

3. The audio playback device as described in claim 1, wherein the executing unit further plays the selected audio file when the touched scroll block is released.

4. The audio playback device as described in claim 1, wherein the touch detection module further detects whether the scroll block is double clicked, the executing module further switches the state of the audio play device between a playing state and a stop state when the scroll block is detected double clicked.

5. The audio playback device as described in claim 1, wherein the storage unit further stores number of each of the audio files for recording an order position of the audio file in the storage unit or in an audio folder, the associating module divides the scroll bar into a plurality of parts according to the total number of the audio files, and associates each of the parts of the scroll bar where the scroll block is operable to be located with one of the audio file.

6. The audio playback device as described in claim 5, wherein the executing module determines which part of the scroll bar the scroll block is located in, and selects the audio file associated with the determined part of the scroll bar.

7. The audio playback device as described in claim 1, wherein the storage unit further stores number of each of the audio files for recording an order position of the audio files in the storage unit or in an audio folder, the associating module divides the scroll bar into a plurality of parts according to a preset distance and the length of the scroll bar, divides each number of the audio file by the number of parts to determine a reminder which is used to determine which part of the scroll bar that the audio file is associated with, and associates each of the parts of the scroll bar where the scroll block is operable to be located with the audio files according to the reminder.

8. The audio playback device as described in claim 7, wherein the executing module determines time(s) that the scroll block is dragged from the head of the scroll bar to the end of the scroll bar and which part of the scroll bar the scroll block is located in to select one audio file.

9. The audio playback device as described in claim 1, wherein the executing module further marks the selected audio file.

10. The audio playback device as described in claim 7, wherein the selected audio file can be marked by highlighting the selected audio file, displaying a frame around the selected audio file, or displaying a cursor on the selected audio file.

11. An audio playback method applied on an audio playback device, the audio playback device comprising a touch screen and a storage unit, the storage unit storing audio files, wherein the method comprises:
controlling the touch screen to display a playlist of the audio files and a scroll bar comprising a scroll block for operating;
associating the position of the scroll block in the scroll bar with the audio files on the playlist;
detecting whether the scroll block is operated; and
determining the position of the scroll block in the scroll bar when the scroll block is dragged, and selecting one audio file according to the determined position of the scroll block in the scroll bar.

12. The audio playback method as described in claim 11, the storage unit further storing general information associated with each of the audio files, wherein the method further comprises:
controlling the touch screen to display the general information associated with one audio file when the one of the audio files is selected.

13. The audio playback method as described in claim 11, wherein the method further comprises:
playing the selected audio file when the touched scroll block is released.

14. The audio playback method as described in claim 11, wherein the method further comprises:
detecting whether the scroll block is double clicked;
switching the state of the audio play device between a playing state and a stop state when the scroll block is detected double clicked.

15. The audio playback method as described in claim 9, the storage unit further storing number of each of the audio files for recording an order position of the audio files in the storage unit or in an audio folder, wherein the method further comprises:
dividing the scroll bar into a plurality of parts according to total number of the audio files; and
associating each of the parts of the scroll bar where the scroll block is operable to be located with one audio file.

16. The audio playback method as described in claim 15, wherein the method further comprises:
determining which part of the scroll bar the scroll block is located in; and
selecting one audio file associated with the determined part of the scroll bar that the scroll block is located in.

17. The audio playback method as described in claim 11, the storage unit further storing number of each of the audio files for recording an order position of the audio file in the storage unit or in an audio folder, wherein the method further comprises:
dividing the scroll bar into a plurality of parts according to a preset distance and a length of the scroll bar;
dividing the number of each of the audio files by the number of parts to determine a reminder which is used to determine which part of the scroll bar the audio file is associated with; and
associating each of the parts of the scroll bar where the scroll block is operable to be located with audio files according to the determined reminder.

18. The audio playback method as described in claim 17, wherein the method further comprises:
determining the time(s) that the scroll block is dragged from the head of the scroll block to the end of the scroll block and which part of the scroll bar the scroll block is located in; and
selecting one audio file according to the determined time(s) that the scroll block is dragged from the head of the scroll block to the end of the scroll block and the determined part of the scroll bar the scroll block is located in.

19. The audio playback method as described in claim 11, wherein the method further comprises:
marking the selected audio file.

20. The audio playback method as described in claim 19, wherein the selected audio file can be marked by highlighting the selected audio file, displaying a frame around the selected audio file, or displaying a cursor on the selected audio file.
